(19) United States
(12) Patent Application Publication
(10) Pub. No.: US 2024/0274874 A1
(43) Pub. Date: Aug. 15, 2024

(54) Anionic Polymers, Electrolytes Comprising the Same, and Methods of Manufacture Thereof

(71) Applicant: Temple University-Of The Commonwealth System of Higher Education, Philadelphia, PA (US)

(72) Inventors: Mike Zdilla, Wallingford, PA (US); Stephanie Wunder, Chadds Ford, PA (US)

(21) Appl. No.: 18/591,852

(22) Filed: Feb. 29, 2024

Related U.S. Application Data
(63) Continuation-in-part of application No. 16/088,928, filed on Sep. 27, 2018, now Pat. No. 11,923,504.
(60) Provisional application No. 62/313,869, filed on Mar. 28, 2016.

(51) Int. Cl. H01M 10/0565; H01M 10/052

(52) U.S. Cl. CPC H01M 10/0565; H01M 10/052; H01M 2300/0082

(57) ABSTRACT

The invention provides a novel anionic polymer useful as a solid electrolyte in a lithium battery. The electrolyte matrix provides directional, flexible, polymeric ion channels with 100% lithium conduction with low-to-no affinity of the matrix for the lithium ion, in part due to the low concentration or absence of lone pair electrons in the anionic polymer.

### CROSS-REFERENCE TO RELATED APPLICATIONS

The present application is a continuation-in-part of U.S. patent application Ser. No. 16/088,928, filed Sep. 27, 2018, which is the national phase application filed under 35 U.S.C. § 371 claiming benefit to International Patent Application No. PCT/US2017/024492, filed Mar. 28, 2017, which claims priority under 35 U.S.C. § 119(e) to U.S. Provisional Application No. 62/313,869, filed Mar. 28, 2016, all of which applications are hereby incorporated by reference in their entireties.

### STATEMENT REGARDING FEDERALLY SPONSORED RESEARCH OR DEVELOPMENT

This invention was made with government support under Grant Nos. CBET 1437814 and DMR 1207221 awarded by The National Science Foundation. The government has certain rights in the invention.

### BACKGROUND OF THE INVENTION

There is a great need for strong, flexible, solid electrolytes with low affinity for ions for the generation of safer solid state batteries. Solid polymer electrolytes have been explored as promising candidates for high-capacity lithium ion batteries due to good mechanical and thermal properties, low processing cost, easy device integration, and stability. These properties make them ideal for device fabrication, reduced flammability, and prevention of device-shorting lithium dendrites. Unfortunately polymer electrolytes generally suffer from a lack of ionic conductivity, and variable selectivity, which make them unviable. The low conductivity of polymer electrolytes stems ultimately from two problems: 1) the high affinity of lithium ions for ligand atoms (in most cases, the ether oxygen atoms of polyethylene oxide, PEO), and 2) ill-defined conduction pathways along grain boundaries or through amorphous phases.

The electrolytes currently used in electrochemical devices such as lithium/lithium ion batteries, hydrogen ion fuel cells, and solar cells are typically liquid or gel electrolytes. However, these liquid or gel electrolytes, although having good room temperature conductivities of >1×10⁻³ S/cm, have safety concerns such as leakage, explosions due to volatile solvents, dendrite formation, and faster formation/migration of degradation products than in a solid electrolyte (Xu, K., Nonaqueous, 2004, Chemical Reviews 104, (10), 4303-4417; Aurbach, D.; Zinigrad, E.; Cohen, Y.; Teller, H., Solid State Ionics 2002, 148, (3-4), 405-416; Brissot, C.; Rosso, M.; Chazalviel, J. N.; Lascaud, S., J of the Electrochemical Society 1999, 146, (12), 4393-4400). Therefore, new materials with architectures that foster enhanced ion migration over a wide temperature range are needed to replace these flammable liquid or gel electrolytes in electrochemical devices.

Solid state electrolytes have previously been investigated because of the expected increase in safety associated with solid state materials, but these electrolytes typically have relatively poor ionic conductivity (Zaghib et al., 2011, J of Power Sources 196, 3949-3954). Currently available solid electrolytes with the highest ionic conductivities are ceramic/glass and other inorganic superionic conductors, with conductivities potentially in the range of 10⁻³ to 10⁻² S/cm (Fergus, 2010, J of Power Sources 195, 4554-4569). In the case of inorganic superionic conductors, the crystalline systems are typically more conductive than the glasses (Kanno and Maruyama, 2001, Journal of the Electrochemical Society 148 (7), A742-A746). The first reported Li⁺ ion superionic conductor, Li₃N, with a high RT ionic conductivity (6×10⁻³ S/cm) for a solid electrolyte, has a low electrochemical stability window making it unsuitable as a solid electrolyte (Alpen et al., 1977, Applied Physics Letters 30 (12), 621-62; Lapp et al., 1983, Solid State Ionics 11 (2), 97-103). Other inorganic superionic solid electrolytes such as the crystalline oxide perovskite lithium lanthanum titanates (La_{0.5}Li_{0.5}TiO₃) (Inaguma et al., 1993, Solid State Communications 86 (10), 689-693), a series of sulfide crystals such as Li₄₋ₓGe₁₋ₓPₓS₄ with the framework structure of γ-Li₃PO₄, referred to as thio-LISICON (e.g. Li_{3.25}Ge_{0.25}P_{0.75}S₄) (Kanno and Maruyama, 2001, Journal of the Electrochemical Society 148 (7), A742-A746), glass ceramics (70Li₂S-30P₂S₅) (Mizuno et al., 2005, Advanced Materials 17 (7), 918-921; Hayashi et al., 2008, Journal of Materials Science 43 (6), 1885-1889) and glassy materials (Li₂S—SiS₂—Li₃PO₄) (Kondo et al., 1992 Solid State Ionics 53, 1183-1186; Takada et al., 1993, Journal of Power Sources 43 (1-3), 135-141), have better electrochemical stability but lower ionic conductivity (˜10⁻³ S/cm). Only Li_{2.9}PO_{3.3}N_{0.46} (LiPON) is used commercially as a solid electrolyte in microbatteries (Bates et al., 1992, Solid State Ionics 53, 647-654; Bates et al., 1993, Journal of Power Sources 43 (1-3), 103-110). The highest RT ionic conductivities for lithium superionic conductors have recently been reported for Li₁₀GeP₂S₁₂ (12 mS/cm). Substitution of Sn for Ge also forms a superionic crystal, Li₁₀SnP₂Si₂ (7 mS/cm), and both materials are metastable (Bron et al., 2013, J Am Chem Soc 135 (42), 15694-15697; Mo et al., 2012, Chemistry of Materials 24 (1), 15-17). However, these electrolytes are brittle, and they have poor adhesion to electrodes due to changes in volume during successive charge/discharge cycles.

Soft-solid electrolytes exhibit desirable flexibility, but have lower conductivity than ceramic/glass/inorganic conductors (e.g., conductivities in the range of 10⁻⁷ to 10⁻⁵ S/cm). Examples of soft-solid electrolytes include polyethylene oxide (PEO) (Abitelli et al., 2010, Electrochimica Acta 55, 5478-5484), PEO/composite blends (Croce et al., 1998, Nature 394, 456-458; Croce et al., 1999, J of Physical Chemistry B 103, 10632-10638; Stephan et al., 2009, J of Physical Chemistry B 113, 1963-1971; Zhang et al., 2010, Electrochimica Acta 55, 5966-5974; Zhang et al., 2011, Materials Chemistry and Physics 121, 511-518; Zhan et al., 2011, J of Applied Electrochemistry 40, 1475-1481; Uvarov, 2011, J of Solid State Electrochemistry 15, 367-389), PEO copolymers/blends (Tsuchida et al., 1988, Macromolecules 21, 96-100; Ryu et al., 2005, J of the Electrochemical Society 152, A158-A163; Park et al., 2004, Electrochimica Acta 50, 375-378), molecular or ionic plastic crystals (Timmermans, 1961, J of Physics and Chemistry of Solids 18, 1-8; Sherwood, 1979, The Plastically Crystalline State: Orientationally Disordered Crystals, Wiley, Chichester, UK; MacFarlane and Forsyth, 2001, Advanced Materials 13, 957-966; Pringle et al., 2010, J of Materials Chemistry 20, 2056-2062; Cooper and Angell, 1986, Solid State Ionics 18-9, 570-576; Yoshizawa-Fujita et al., 2007, Electrochemistry Communications 9, 1202-1205.), and low molecular weight glymes (Henderson et al., 2003, Chemistry of Materials 15, 4679-4684; Henderson et al., 2003, Chemistry of Materials 15, 4685-4690; Seneviratne et al., 2004, J of Physical Chemistry B 108, 8124-8128; Andreev et al., 2005, Chemistry of Materials 17, 767-772; Henderson et al., 2005, Chemistry of Materials 17, 2284-2289; Henderson, 2006, J of Physical Chemistry B 110, 13177-13183; Zhang et al., 2007, Angewandte Chemie-International Edition 46, 2848-2850; Zhang et al., 2007, J of the American Chemical Society 129, 8700-8701). Another example of a soft-solid electrolytic material is NAFION™ polymer, which has a hydrophobic perfluorinated matrix that contains anion-coated (typically —SO³⁻) percolating clusters, and channels through which oppositely charged ions can migrate (Mauritz and Moore, 2004, Chemical Reviews 104, 4535-4586).

For PEO systems, conductivity has been shown to occur primarily through the amorphous phase, where ion migration is coupled to slow backbone segmental motions (Borodin and Smith, 2006, Macromolecules 39, 1620-1629), so that decreases in crystallinity (Abitelli et al., 2010, Electrochimica Acta 55, 5478-5484; Stephan et al., 2009, J of Physical Chemistry B 113, 1963-1971; Zhang et al., 2010, Electrochimica Acta 55, 5966-5974; Zhan et al., 2011, J of Applied Electrochemistry 40, 1475-1481), and alignment of polymer chains (Bruce, 1996, Philosophical Transactions of the Royal Society a-Mathematical Physical and Engineering Sciences 354, 1577-1593; Andreev and Bruce, 2000, Electrochimica Acta 45, 1417-1423), increase conductivity.

Other approaches to improve ionic conductivities in soft-solid electrolytes are based on the observation that molecular organization rather than disordered structures foster ion mobility. In particular, this is true for materials in which there are alternative, low activation energy pathways for ion migration, such as along and between organized, aligned polymer or liquid crystalline polymer chains (Andreev and Bruce, 2000, Electrochimica Acta 45, 1417-1423; Golodnitsky and Peled, 2000, Electrochimica Acta 45, 1431-1436; Dias et al., 1998, Electrochimica Acta 43, 1217-1224; Hubbard et al., 1998, Electrochimica Acta 43, 1239-1245; Imrie et al., 1999, Advanced Materials 11, 832-834; Yoshio et al., 2004, J of the American Chemical Society 126, 994-995; Kishimoto et al., 2003, J of the American Chemical Society 125, 3196-3197; Yoshio, 2006, J of the American Chemical Society 128, 5570-5577; Shimura et al., 2008, J of the American Chemical Society 130, 1759-1765; Ichikawa, 2011, J of the American Chemical Society 133, 2163-2169); along polymeric/inorganic nanoparticle interfaces, possibly due to weakening of the ether O—Li⁺ bond (Shen, 2009, Electrochimica Acta 54, 3490-3494; Chen-Yang et al., 2008, J of Power Sources 182, 340-348; Marcinek et al., 2000, J of Physical Chemistry B 104, 11088-11093; Borodin et al., 2003, Macromolecules 36, 7873-7883); and along ion channels in low molecular weight glymes and trilithium compounds (Gadjourova et al., 2001, Nature 412, 520-523; MacGlashan et al., 1999, Nature 398, 792-794; Gadjourova et al., 2001, Chemistry of Materials 13, 1282-1285; Stoeva et al., 2003, J of the American Chemical Society 125, 4619-4626; Staunton et al., 2005, J of the American Chemical Society 127, 12176-12177; Zhang et al., 2007, J of the American Chemical Society 129, 8700-8701; Zhang et al., 2008, Chemistry of Materials 20, 4039-4044; Moriya et al., 2012, Chemistry-A European J 18, 15305-15309). Decreased interactions between mobile cations such as Li⁺ and their associated anions and/or solvating matrix, such as in microphase separated solid polymer electrolytes (SPEs) have also been shown to increase cation mobility and conductivity (Ryu et al., 2005, J of the Electrochemical Society 152, A158-A163). For the design of soft solid electrolytes with higher conductivities, crystalline solids in which channel walls have low affinity for the enclosed ions are desired.

Key problems that remain for the use of solid electrolytes in all solid-state Li batteries, aside from the general concerns of stability windows and compatibility with solvents when used in air or liquid flow-through cathodes, are improvements in room temperature ionic conductivities, increased charge/discharge rates, high lithium ion transference numbers to avoid polarization effects, and the maintenance of good electrode/electrolyte contact during the volume changes that occur in the electrodes during repeated charge/discharge cycles (Doyle et al., 1994, Electrochimica Acta 39, (13), 2073-81; Thomas et al., 2000, J of Power Sources 89, (2), 132-138; Gadjourova et al., 2001, Nature 412, (6846), 520-523). The engineering of solid-state organic materials with specific ion conduction pathways that can enhance ion migration offers promise as a means to achieve higher solid-state ionic conductivities, while soft, more malleable organics may better adhere to electrodes. However, there has been only limited progress in this area.

Thus, there is a continuing need in the art for solid state electrolytes, including anionic polymers electrolytes, for electrochemical devices. The present invention addresses this continuing need in the art.

### SUMMARY OF INVENTION

In one aspect, the invention relates to an anionic polymer comprising a Lewis adduct. In one embodiment, the polymer is the copolymer of a Lewis acid and a Lewis base. In another embodiment, the polymeric backbone lacks lone pair electrons. In another embodiment, the polymer lacks lone pair electrons.

In another aspect, the invention relates to an anionic polymer represented by Formula I:

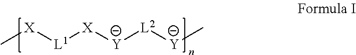

wherein L¹ and L² are each independently a divalent residue of an organic molecule, X is selected from the group consisting of CR¹R², NR¹, SiR¹R², PR¹, O, S, Y is selected from the group consisting of BR¹R², and R¹ and R² are each independently selected from the group consisting of H, and optionally substituted alkyl, haloalkyl, alkenyl, alkynyl, aryl, cycloalkyl, heteroaryl, heterocycloalkyl, arylalkyl, heteroarylalkyl, cycloalkylalkyl, and heterocycloalkylalkyl, and can optionally be joined to form a ring. In one embodiment, the polymer is represented by Formula II. In another embodiment, the polymer is represented by Formula III. In another embodiment, the polymer is represented by Formula IV.

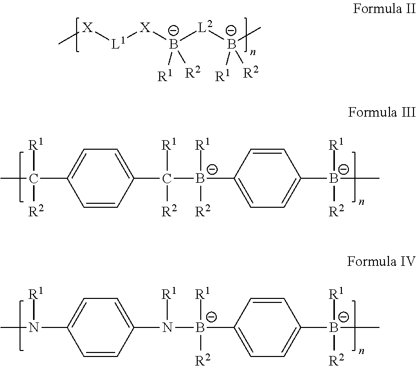

In another aspect, the invention relates to a composition comprising an anionic polymer, wherein a polymer molecule is adjacent to an ion channel. In another aspect, the invention relates to a composition comprising an anionic polymer and a counterion. In one embodiment, the counterion is selected from the group consisting of Li⁺, Na⁺, and Mg²⁺. In one aspect, the invention relates to a film comprising an anionic polymer. In another aspect, the invention relates to a crystal comprising an anionic polymer.

In one aspect, the invention relates to a solid electrolyte comprising an anionic polymer. In another aspect, the invention relates to a battery comprising an electrolyte comprising an anionic polymer.

In one aspect, the invention relates to a method of preparing an anionic polymer, the method comprising mixing a Lewis acid and a Lewis base. In one embodiment, the Lewis acid is an organoborane and the Lewis base is an organometallic compound.

In one aspect, the invention relates to a method of growing an anionic polymer on a substrate, the method comprising dipping the substrate in a precursor, rinsing the substrate, and dipping the substrate in a different precursor. In one embodiment, the precursors are selected from the group consisting of an organoborane and an organometallic compound. In another embodiment, the substrate is a conductive electrode. In another embodiment, the substrate comprises nanoporous SiO₂ on Li ceramics.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 depicts the design of an exemplary embodiment of an anionic polymer and methods of growing thereof on a substrate, for example on an electrode. The sequential, alternating attachment of organodilithium salts with diboranes generates a 2-D directional polymer with 1-D ion channels with almost no affinity for the Li counterion.

FIG. 2, comprising FIGS. 2A and 2B, depicts examples of lone-pair free anionic polymers. FIG. 2A depicts how traditional PEO polymers chelate Li⁺ through multiple lone pairs, generating a barrier to migration, wherein the motion of mobile counteranions lowers ion selectivity. FIG. 2B depicts borate-based polymers lacking lone pairs, wherein anion atoms are located in the polymer backbone, permitting facile, selective ion migration.

FIG. 3 depicts polymer building blocks used in synthesizing the anionic polymers of the invention.

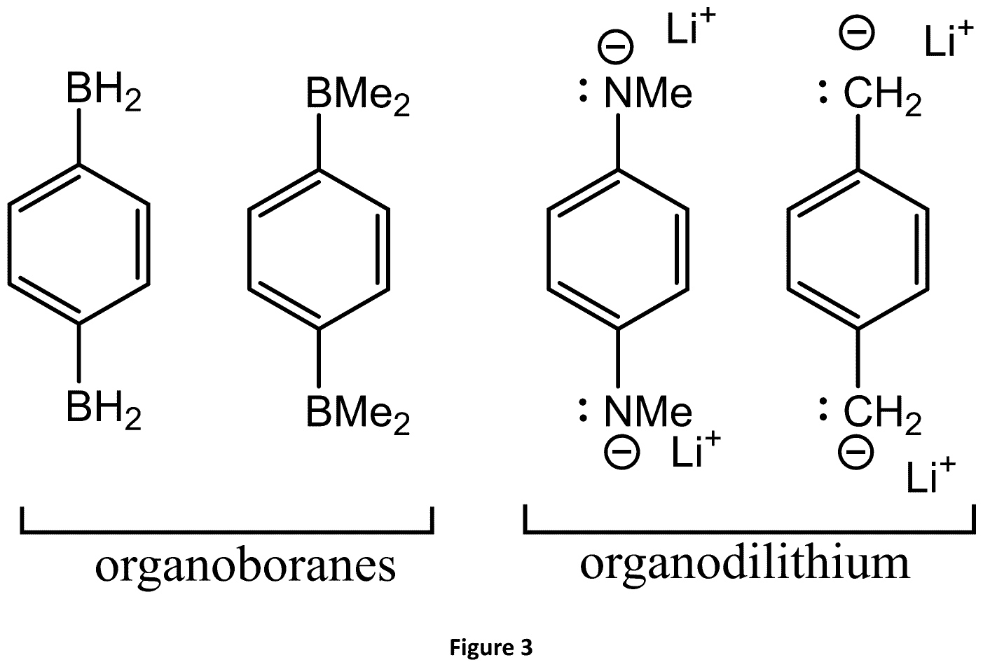

FIG. 4 depicts the delocalization of nitrogen lone pair for decreased Li⁺ affinity in a polymeric backbone comprising nitrogen, versus a polymeric backbone without nitrogen wherein there are no lone pairs for attachment to Li⁺.

FIG. 5 depicts the sequential dip approach for controlled step-growth polymerization, also known as the “dip-rinse-dip” approach.

FIG. 6 depicts SEM showing SiO₂ coated LISICON functionalized with surface organosilane interface.

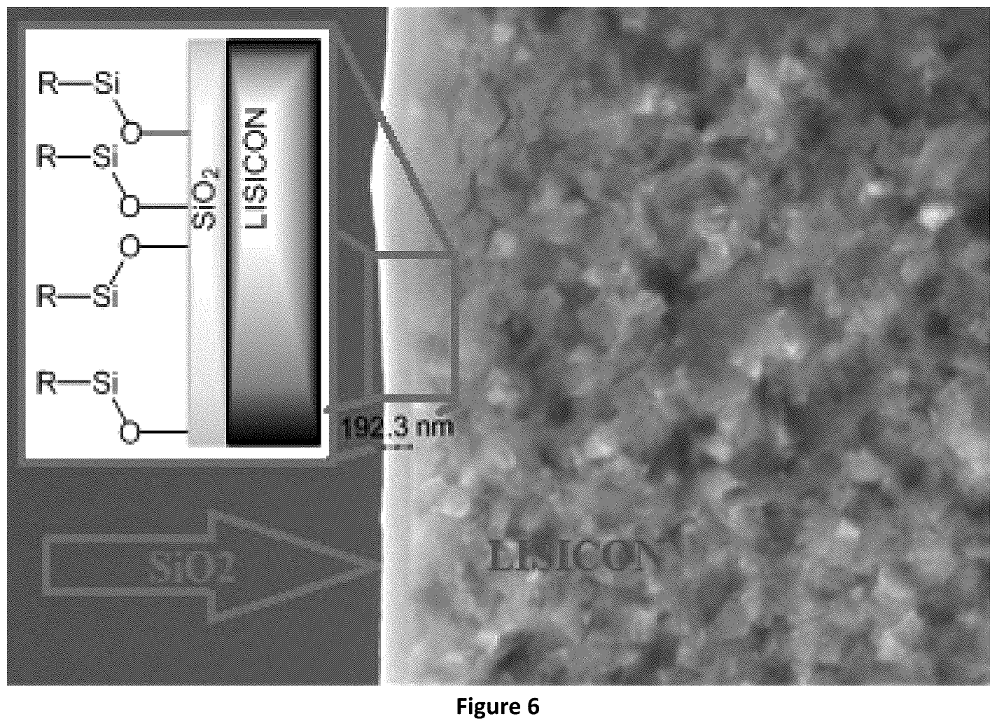

### DETAILED DESCRIPTION

It is to be understood that the figures and descriptions of the present invention have been simplified to illustrate elements that are relevant for a clear understanding of the present invention, while eliminating, for the purpose of clarity, many other elements found in the art related to polymer compositions, battery technology, electrolytes useful for batteries or other electrochemical devices, and the like. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods, materials and components similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### DESCRIPTION

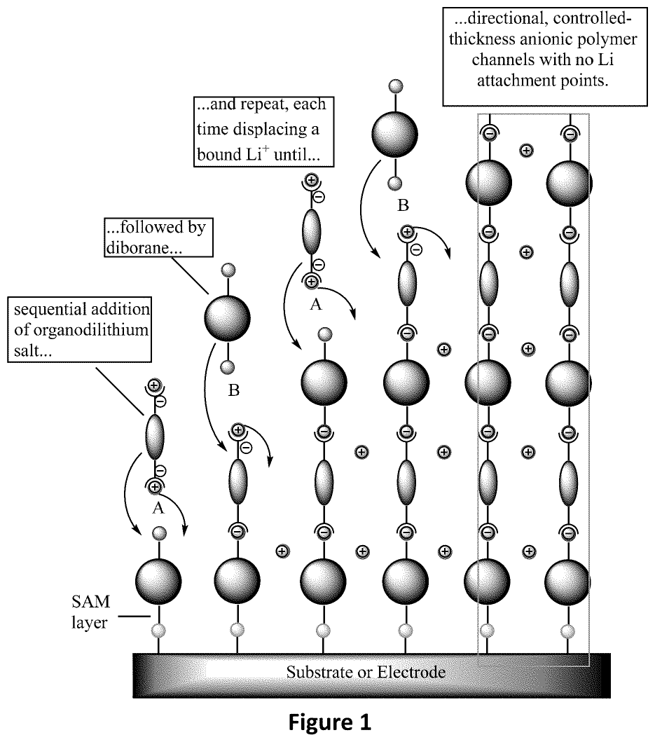

In one aspect, the invention relates to an entirely new type of conductive polymer with excellent thermal and mechanical properties, at the same time solving the conduction directionality, lithium affinity, and ion selectivity problems generally associated with solid electrolytes. According to the current invention, electrolyte components are generated by the step-growth of linear polymers of alternating diborane and organodilithium functionality with a sequential dip-rinse method. As illustrated in FIG. 1, each subsequent addition binds the anion of the lithium salt to a boron atom, converting all lone pairs into bond pairs; the formerly bound lithium ion, having no remaining lone pairs to bind it, is displaced into the ionic channel, and is fixed by coulombic charge balance forces (ionic bonding) but with no lone electron pairs in the polymer for direct attachment.

In another aspect, the invention relates to a single ion conductor (SIC) polymer and polymer/ceramic composites with the potential to form high ionic conductivity, dendrite inhibiting, processable solid electrolytes with good power performance for use with lithium metal anodes.

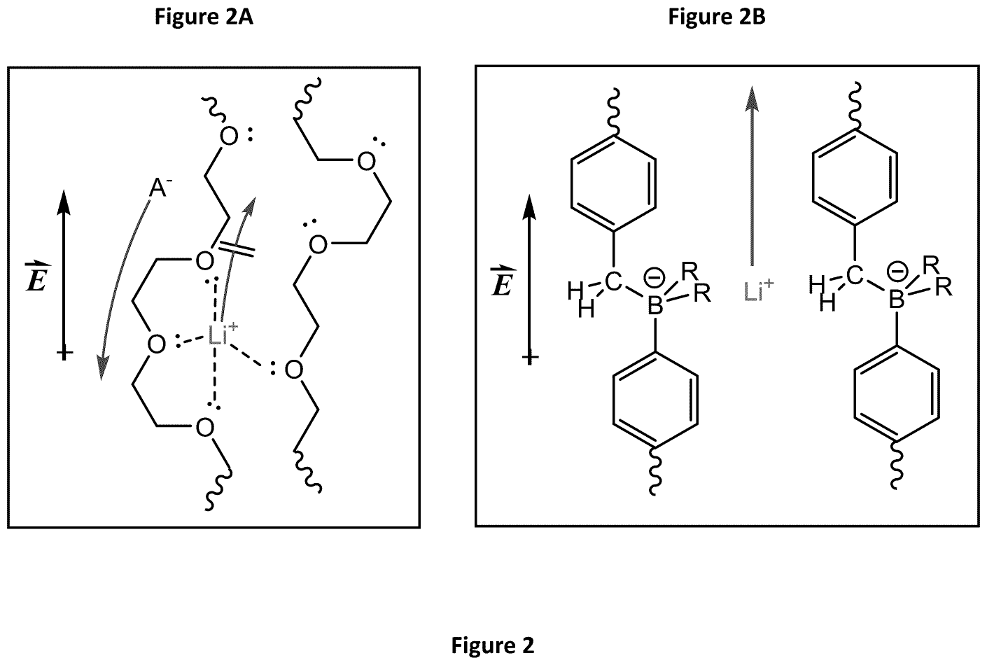

The major challenge with polymer electrolytes is that the lone-pair electrons (needed to solubilize Li⁺) also bind to Li⁺ through coordinate covalent bonds. The approach of the invention takes advantage of concomitant generation of negatively charged polymers that also solubilize Li⁺, but lack coordinating lone pairs to bind the ions tightly to the electrolyte matrix, as illustrated in FIG. 2. While borate salts have been used as lithium ion sources due to this low-affinity property, the invention extends this utility to embedding the low-affinity borate anion into the polymer itself. Another challenge with polymer electrolytes is that they are not conductive through the bulk crystalline phase, but rather, along grain boundaries or through amorphous phases, so that the conduction path is tortuous. The invention provides directional, flexible, polymeric ion channels with 100% lithium conduction (since the anions are fixed as part of the polymer backbone) with low-to-no affinity of the matrix for the lithium ion. The polymers of the invention are prepared using relatively inexpensive, scalable ingredients, and with no need for doping molecules, nanostructures, or liquids into the separator. Materials such as these lead to improved and unprecedented ionic conductivity for polymers. The thermal and mechanical properties are comparable to other organic polymers, and are ideal for device fabrication, with the added benefits of inherent directionality, and controllable thickness, achieving the goal of realistically sized electrolyte components thinner than 20 km.

### Compositions of the Invention

In one aspect, the invention relates to an anionic polymer comprising a Lewis adduct. In one embodiment, the polymer is the copolymer of a Lewis acid and a Lewis base. A Lewis acid is a molecule, ion, or chemical species in general, which is capable of accepting an electron pair from another molecule, ion, or chemical species in general, by means of coordination, and/or bond formation. A Lewis base is similarly a molecule, ion, or chemical species in general, which is capable of donating an electron pair to another molecule, ion, or chemical species in general, by means of coordination, and/or bond formation. A Lewis adduct is a molecule, ion, or chemical species in general, which results from the reaction between a Lewis acid and a Lewis base.

In one embodiment, a Lewis acid used in the compositions and methods of the invention is a chemical species comprising at least one atom with an empty orbital, such as for example an empty p orbital. In another embodiment, the Lewis acid is an organoborane comprising a boron atom and an organic residue.

Exemplary organoboranes include, but are not limited to, 1,4-bis(diarylboryl)benzenes, 1,4-bis(diarylboryl)naphthalenes, 9,10-bis(diarylboryl)anthracenes, 1,4-bis(dialkylboryl)benzenes, 1,4-bis(dialkylboryl)naphthalenes, and 9,10-bis(dialkylboryl)anthracenes. In one embodiment, the organoborane is selected from the group comprising benzenediborane and bis(dimethylboryl)benzene. The organoborane compounds may be synthesized according to any method known in the art.

In some embodiments, the Lewis acid is a haloborane comprising a boron atom and a halogen atom. Exemplary haloboranes include, but are not limited to, BH₂F, BH₂Cl, BH₂Br, and BH₂I. In some embodiments, the haloborane is complexed with an organic residue. In some embodiments, the organic residue is an organosulfur compound. Exemplary complexes include, but are not limited to, fluoroborane dimethyl sulfide complex, fluoroborane diethyl sulfide complex, fluoroborane ethyl methyl sulfide complex, chloroborane dimethyl sulfide complex, chloroborane diethyl sulfide complex, chloroborane ethyl methyl sulfide complex, bromoborane dimethyl sulfide complex, bromoborane diethyl sulfide complex, bromoborane ethyl methyl sulfide complex, iodoborane dimethyl sulfide complex, iodoborane diethyl sulfide complex, and iodoborane ethyl methyl sulfide complex.

In one embodiment, a Lewis base used in the compositions and methods of the invention is a chemical species comprising at least one atom with a pair of electrons available to occupy an empty orbital of a Lewis acid. In another embodiment, the Lewis base is the anion of a metallic salt of an organic compound. In another embodiment, the Lewis base is a lithium salt. In another embodiment, the lithium salt is selected from the group comprising the dilithium salts of 1,4-bis(methylamino)benzene and p-xylene. The pair of electrons conferring Lewis base character to the molecule, reacts with an empty orbital of a Lewis acid and creates a new bond in a Lewis adduct.

In some embodiments, a Lewis base used in the compositions and methods of the invention comprise two atoms with a pair of electrons available to occupy an empty orbital of a Lewis acid. In some embodiments, the Lewis base is the dianion of a metallic salt of an organic compound. In some embodiments, the Lewis base is a dilithium salt. Exemplary dilithium salts include, but are not limited to, dilithium salts of ethane, propane, butane, tert-butane, pentane, hexane, heptane, octane, nonane, decane, undecane, dodecane, tridecane, tetradecane, pentadecane, hexadecane, heptadecane, octadecane, nonadecane, and eicosane.

In one aspect, the invention relates to an anionic polymer having a polymeric backbone which lacks lone pair electrons. In one embodiment, the entire polymer lacks lone pair electrons. An anionic polymer is typically part of a composition further comprising a positive counterion such as a metallic cation. If the anionic polymer contains lone pairs of electrons, the counterion can coordinate to these lone pairs of electrons and therefore exhibit low mobility. A composition comprising an anionic polymer having no lone pair of electrons, either just in its polymeric backbone, or preferably in the entirety of the polymer, will therefore exhibit low counterion affinity and high degree of counterion mobility.

In one aspect, the invention relates to an anionic polymer represented by Formula I.

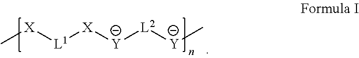

In one embodiment, L¹ and L² are each independently a divalent residue of an organic molecule. In another embodiment, X is selected from the group consisting of CR¹R², NR¹, SiR¹R², PR¹, O, S. In another embodiment, Y is selected from the group consisting of BR¹R². In another embodiment, R¹ and R² are each independently selected from the group consisting of H, and optionally substituted alkyl, haloalkyl, alkenyl, alkynyl, aryl, cycloalkyl, heteroaryl, heterocycloalkyl, arylalkyl, heteroarylalkyl, cycloalkylalkyl, and heterocycloalkylalkyl, and can optionally be joined to form a ring.

In another aspect, the invention relates to an anionic polymer represented by Formula II. In one embodiment, the polymer is represented by Formula III. In another embodiment, the polymer is represented by Formula IV.

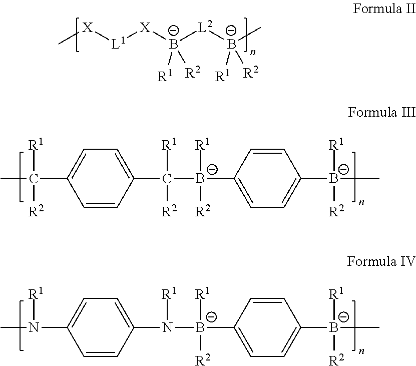

In another aspect, the invention relates to an anionic polymer represented by Formula V:

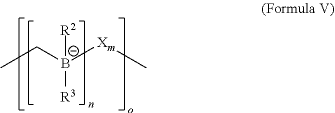

wherein R¹ a divalent linker comprising one or more selected from the group consisting of alkyl, branched alkyl, cycloalkyl, haloalkyl, alkanol, aryl, heteroaryl, arylalkyl, arylalkanol, heteroarylalkyl, and heteroarylalkanol;
wherein R² and R³ are each independently selected from the group consisting of H, F, alkyl, haloalkyl, alkenyl, alkynyl, aryl, cycloalkyl, heteroaryl, heterocycloalkyl, arylalkyl, heteroarylalkyl, cycloalkylalkyl, and heterocycloalkylalkyl, and can optionally be joined to form a ring;
wherein X is a divalent monomer comprising one or more selected from the group consisting of alkyl, branched alkyl, cycloalkyl, haloalkyl, alkanol, aryl, heteroaryl, arylalkyl, arylalkanol, heteroarylalkyl, and heteroarylalkanol;

$$wherein n = 1 - 10 , 000 ;$$

$$wherein m = 0 - 10 , 000 ;$$

$$and$$

$$wherein o = 1 - 10 , 0.$$

In some embodiments, the compound of Formula V is a compound of Formula VI:

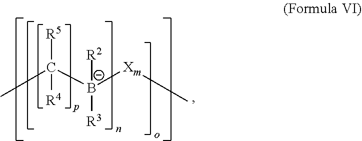

wherein R⁴ and R⁵ are each independently selected from the group consisting of H, F, alkyl, haloalkyl, alkenyl, alkynyl, aryl, cycloalkyl, heteroaryl, heterocycloalkyl, arylalkyl, heteroarylalkyl, cycloalkylalkyl, and heterocycloalkylalkyl, and can optionally be joined to form a ring.

In some embodiments, the anionic polymer comprises a second structural copolymer to increase mechanical stability. For example, in Formula (V) the anionic polymer may comprise a boron polymer component ([—R¹—BR²R³—]ₙ; Component A) and a structural component (—Xₘ—; Component B). In some embodiments, the polymer is crosslinked. For example, in Formula (V), R¹, R², R³, R⁴, R⁵, and X may comprise an additional functional group for cross-polymerization. Exemplary functional groups suitable for cross-polymerization include, but are not limited to, —COOH, —COCl, —OH, —NH₂, —NCO, —CCH, and —N₃. In one aspect, the invention relates to a composition comprising an anionic polymer of the invention further comprising an ion channel adjacent to a polymer molecule. An ion channel refers generally to a space in a composition wherein an ion, more specifically a cation, and even more specifically a metallic cation, can move through with a certain degree of mobility. Given the polymerization methods described herein and the inherent morphological characteristics of the resulting polymers, the ionic channels comprised by the compositions of the invention are directional, flexible, and have a high degree of counterion conduction. In particular the lack of lone pair of electrons in the polymeric backbone, or the entirety of the polymer, results in ion channels with low-to-no affinity of the polymeric matrix to the lithium ions which are the typical counterions used. In one embodiment, the counterion is selected from the group consisting of Li⁺, Na⁺, and Mg²⁺.

In some embodiments, the Component B is a longer polymer, providing greater flexibility. In some embodiments, the Component B comprises between 15 and 10000 units of X. In some embodiments, the Component B is a shorter polymer, providing a more rigid polymer and a shorter distance for a counterion to travel as it conducts. In some embodiments, Component B comprises between 1 and 14 units of X. In some embodiments, a mixture of Components B are utilized.

In one aspect, the invention relates to a film comprising an anionic polymer of the invention. In one embodiment, the film is flexible, while in other embodiments the film is rigid or semi-rigid. In another aspect, the invention relates to a crystal comprising the anionic polymer of the invention. In one embodiment, the film can be prepared by solution-phase mixing of 1:1 solutions of diborane and organodilithium reagents, wherein the resulting mixture is dried into a film by solvent evaporation.

In one aspect, the invention relates to a solid electrolyte comprising an anionic polymer of the invention. In one embodiment, the solid electrolyte can be grown on a substrate such as for example a conductive electrode. In one embodiment, the electrolyte is used in a battery. In one embodiment, the battery is rechargeable. One popular type of rechargeable battery is the lithium ion battery. Compared to other types of rechargeable batteries, lithium ion batteries provide high energy densities, lose a minimal amount of charge when not in use, and do not exhibit memory effects. Due to these beneficial properties, lithium ion batteries have found use in various portable electronic devices such as cell phones, transportation, back-up storage, defense, and aerospace applications.

### Methods of the Invention

In one aspect, the invention relates to a method of preparing an anionic polymer comprising a Lewis adduct, the method comprising mixing a Lewis acid and a Lewis base. In one embodiment, the Lewis acid is an organoborane and the Lewis base is an organometallic compound. In one embodiment, the method can be employed to prepare a film comprising an anionic polymer of the invention, wherein the film can be flexible, rigid, or semi-rigid. In one embodiment, the method comprises solution-phase mixing of 1:1 solutions of diborane and organodilithium reagents, wherein the resulting mixture is dried into a film by solvent evaporation. In another aspect, the method can be used to grow a crystal comprising an anionic polymer of the invention.

In some embodiments, the Lewis acid is a haloborane and the Lewis base is an organometallic compound. In some embodiments, the method can be employed to prepare a film comprising an anionic polymer of the invention, wherein the film can be flexible, rigid, or semi-rigid. In one embodiment, the method comprises solution-phase mixing of 1:1 solutions of haloborane and organodilithium reagents, wherein the resulting mixture is dried into a film by solvent evaporation. In another aspect, the method can be used to grow a crystal comprising an anionic polymer of the invention.

In some embodiments, the method further comprises forming a copolymer. In some embodiments, the copolymer is formed by reacting a boron polymer component (Component A) with a structural copolymer component (Component B). In some embodiments, a functional group on Component A reacts with a functional group on Component B to form the copolymer. Exemplary functional groups include, but are not limited to, —COOH, —COCl, —OH, —NH₂, —NCO, —CCH, and —N₃. For example, a terminal haloborane of Component A may react with a functional group of Component B. Alternatively, a functional group on a side chain of Component A may react with a functional group on Component B.

In some embodiments, the copolymer is formed by a terminal end of Component A may initiate polymerization to form a block copolymer. Exemplary polymerization include, but are not limited to, ring opening, free radical, anionic, cationic, and coordination polymerization.

In some embodiments, the method further comprises a step of crosslinking a polymer of the present invention. For example, in Formula (V), the method may comprise a step of reacting a functional group on R¹, R², R³, R⁴, R⁵, and/or X of a first polymer chain with a functional group on R¹, R², R³, R⁴, R⁵, and/or X of a second polymer chain. Exemplary functional groups suitable for cross-polymerization include, but are not limited to, —COOH, —COCl, —OH, —NH₂, —NCO, —CCH, and —N₃.

In another aspect, the invention relates to a method of growing an anionic polymer on a substrate. In some embodiments, the method comprises dipping the substrate in a precursor, rinsing the substrate, and dipping the substrate in a different precursor. In one embodiment, the precursors are selected from the group consisting of an organoborane and an organometallic compound.

In some embodiments, the method comprises flowing a precursor over the surface of the substrate, rinsing the substrate, and flowing a different precursor over the substrate. In some embodiments, the method is performed in an air-free, or essentially air-free, atmosphere. In some embodiments, the method is performed in a nitrogen or argon atmosphere. In some embodiments, the method is performed in a sealed reactor. In some embodiments, the method is performed in a sealed flow reactor. In some embodiments, the precursors are selected from the group consisting of a haloborane and an organometallic compound.

Generally, boron polymer components of anionic polymers of Formula (VI) are made from any set of precursor fragments according to Scheme 1:

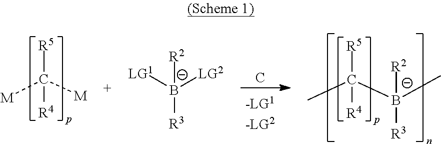

wherein LG¹ and LG² are leaving groups. In some embodiments, LG¹ and LG² are —Cl and —S⁺Me₂.

These boron polymer component chains can be assembled with other preassembled short-chain polymers with Lewis base components to form block copolymers of Formula VI, according to Scheme 2:

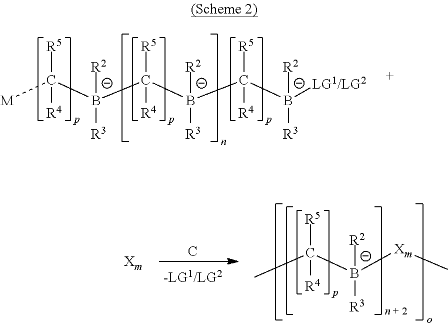

wherein X is a divalent monomer comprising one or more selected from the group consisting of alkyl, branched alkyl, cycloalkyl, haloalkyl, alkanol, aryl, heteroaryl, arylalkyl, arylalkanol, heteroarylalkyl, and heteroarylalkanol.

In some embodiments, R² and R³ are H. In some embodiments, the compound of Formula (VI) is a compound of Formula (VIH)

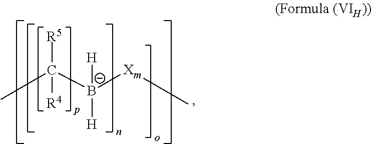

In some embodiments, the method further comprises forming a compound of Formula (VI) from a compound of Formula (VIH) according to Scheme 3:

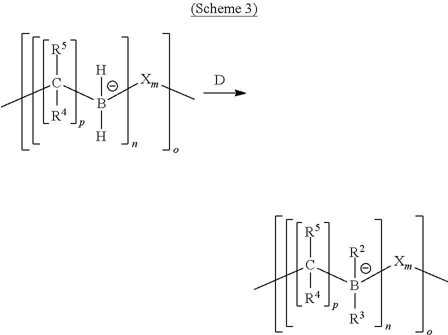

In some embodiments, step-growth polymerizations are achieved through the sequential addition of all above precursors into solution stepwise or simultaneously. In some embodiments, the polymers are sequentially grown on a substrate surface by successive dipping of polymer into solutions of precursors. In some embodiments, the polymers are grown on bead supports using flow chemistry via the rinsing and switching of beads via an automated flow apparatus to grow polymers of controlled length and composition.

In another embodiment, the substrate is a conductive electrode. In another embodiment, the substrate is first coated by a self-assembled monolayer (SAM), constructed for example using p-hydroxythiophenol. In another embodiment, the SAM is constructed on a gold layer. In some embodiments, the substrate comprises SiO₂ surfaces or silicon substrates that have been oxidized on one side to form SiO₂, and further functionalized with organo or chlorosilanes as the initial monomer. In another embodiment, the substrate comprises nanoporous SiO₂ on Li ceramics. In another embodiment, nm nanoporous SiO₂ coatings are used on Li ceramic conductors to provide covalent attachment to the single ion conductor (SIC) polymers, and thus form hybrid SIC solid electrolytes.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the compositions of the present invention and practice the claimed methods. The following working examples therefore, specifically point out the preferred embodiments of the present invention, and are not to be construed as limiting in any way the remainder of the disclosure.

### Example 1: Precursors

The precursors used to synthesize the polymers of the invention can be employed in both solution phase approaches as well as controlled growth on a substrate. Diboranes and organodilithium compounds are both used to synthesize the anionic polymers of the invention by the methods described herein. Example of diboranes include benzenediborane and bis(dimethylboryl)benzene, while organolithium compounds include lithium salts such as the dilithium salts of 1,4-bis(methylamino)benzene and p-xylene, both obtainable by lithiation from alkyllithium reagents.

### Example 2: Solution Phase Polymer Synthesis

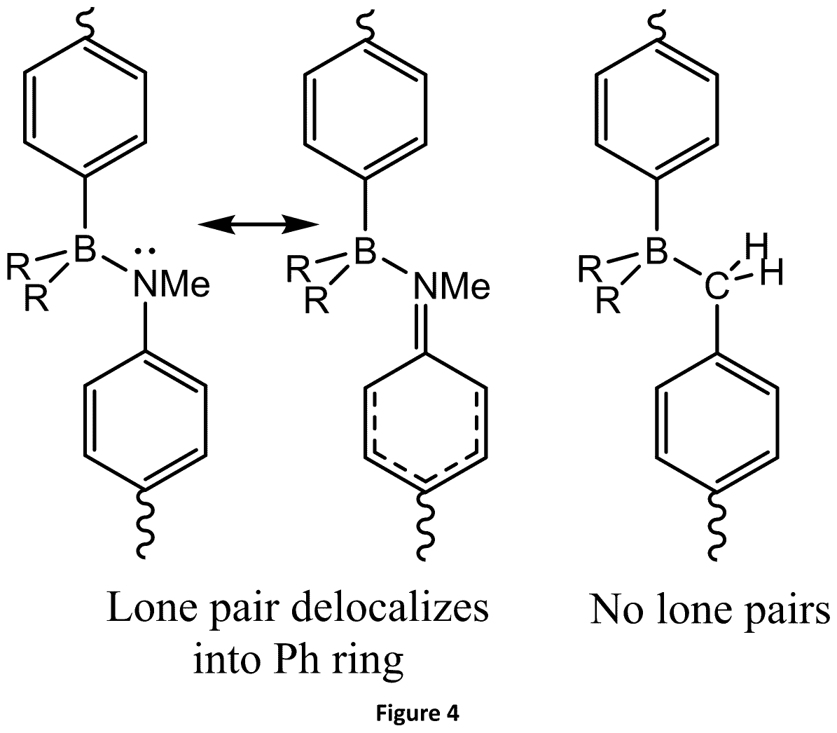

Solution-phase preparation of borate heteropolymers can be achieved by the mixing of 1:1 solutions of diborane and organodilithium reagents to generate short polymers. Step growth polymerization in solution generally results in short oligomeric segments due to polymer termination by the excess reagent. For this reason, reagents are measured with high analytical precision to obtain a 1:1 ratio of reagents as accurately as possible. The product is a solid, amorphous mixture of oligomers or short polymers, which are dried into a film by solvent evaporation and examined for conductivity properties using electrochemical impedance spectroscopy (EIS). Physical property characterization include thermal analysis, differential scanning calorimetry (DSC) and thermogravimetric analysis (TGA), molecular weight and molecular weight distribution by size exclusion chromatography (SEC), and mechanical properties by dynamic mechanical analysis (DMA). The materials are structurally characterized using mass spectrometry, X-ray diffraction, and ¹H NMR spectroscopy. The absence of Lewis basic lone pair electrons results in excellent conductivity. While the amidoborane polymers technically have one lone pair, it is delocalized into the phenyl ring, making it less available for binding to lithium. The xyleneborane polymers typically exhibit superior conductivity due to the complete absence of lone pair electrons (FIG. 4).

### Example 3: Growth of Oriented Polymers on Substrate

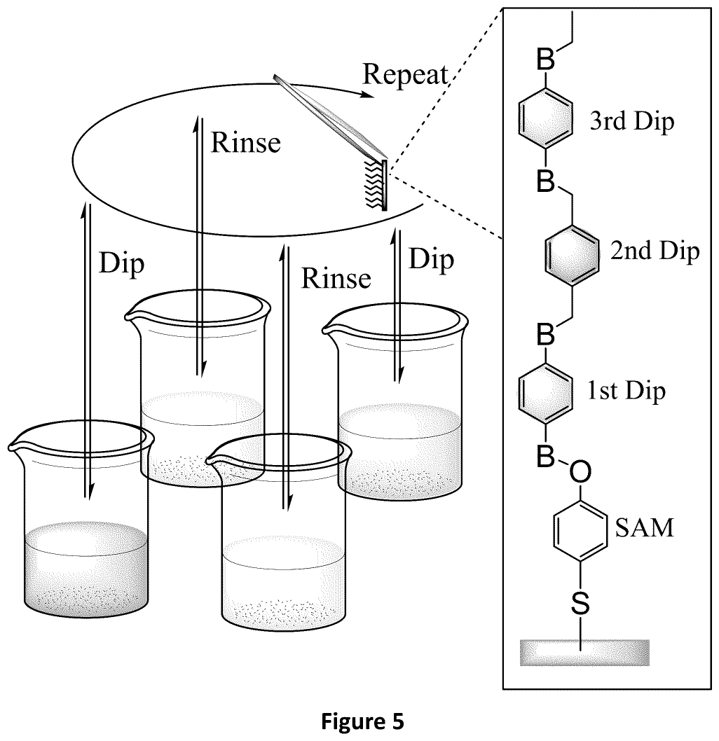

Controlled growth of oriented, low-affinity polymers can be achieved directly onto a fabricated electrode. While electrode-electrolyte interface issues are typically a challenge, for purposes of measurement of ionic conductivities, the polymers can be grown onto a conductive gold electrode by attachment to a self-assembled monolayer (SAM). The initial SAM can be constructed at the gold surface using a p-hydroxythiophenol, and the step growth begins with attachment of diborane to the SAM. The polymers can be grown to exact chain lengths by a sequential, alternating dip-rinse-dip cycle, where the SAM-coated substrate is dipped in the following sequence: diborane: rinse: organolithium precursor: rinse, then repeat. With each dip into a reagent, the polymer grows by one unit (FIG. 5). These films can be characterized using EIS, TGA, DSC, AFM and quartz crystal microbalance. As these polymers grow with high fidelity onto a crystalline gold surface, a crystalline material can be obtained, in which case the polymers can be structurally characterized using X-ray diffraction to obtain precise information on the 3D structure and constellation of the polymers and, optionally, the resting location of the lithium ions.

### Example 4: Attachment to Composite Ceramics or Electrodes

Directional borane polymers are also grown on SiO₂ surfaces or onto silicon substrates that have been oxidized on one side (to form SiO₂, and functionalized with organo or chlorosilanes as the initial monomer. Hybrid ceramic/organic separators can be fabricated in this manner, since it has been already demonstrated that a SiO₂ layer (˜200 nm) functionalized with polyethylene glycol silanes and lithium salts on a LISCION membrane has little interfacial resistance, with similar conductivity for LISCION with or without SiO₂ between stainless steel electrodes. Interfaces to Li/Si alloys can also fabricated, where a thin Si layer on top of a Li/Si anode can be oxidized (to form SiO₂), followed by functionalization using alkyl silanes.

### Example 5: Haloborane Method Precursors

The precursors used to synthesize the polymers of the invention can be employed in both solution phase approaches as well as controlled growth on a substrate. Haloboranes and organodilithium compounds are both used to synthesize the anionic polymers of the invention by the methods described herein. Examples of haloboranes include fluoroborane, chloroborane, bromoborane, and iodoborane, as well as dimethyl sulfide, ethyl methyl sulfide, and diethyl sulfide complexes thereof. Organolithium compounds include dilithium salts, such as those of ethane, propane, butane, tert-butane, pentane, hexane, heptane, and octane.

### Example 6: Solution Phase Polymer Synthesis

Solution-phase preparation of borate heteropolymers can be achieved by the mixing of 1:1 solutions of haloborane complexes and organodilithium reagents to generate short polymers. Step growth polymerization in solution generally results in short oligomeric segments due to polymer termination by the excess reagent. For this reason, reagents are measured with high analytical precision to obtain a 1:1 ratio of reagents as accurately as possible. The product is a solid, amorphous mixture of oligomers or short polymers, which are dried into a film by solvent evaporation and examined for conductivity properties using electrochemical impedance spectroscopy (EIS).

As an example, poly(1,2-diboraneylethylene) (PDBE) is prepared from ethyl-1,2-dilithium by the following route:

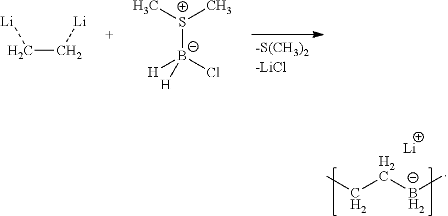

Similarly, substitution of propyl-1,3-dilithium yields poly(1,3-diboraneylpropane) (PDBP):

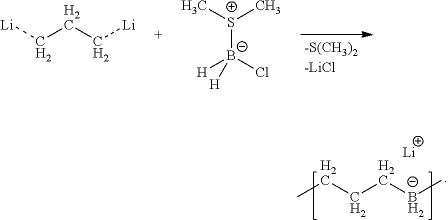

### Example 7: Growth of Oriented Polymers on Substrate

Controlled growth of oriented, low-affinity polymers can be achieved directly onto a fabricated electrode. While electrode-electrolyte interface issues are typically a challenge, for purposes of measurement of ionic conductivities, the polymers can be grown onto a conductive gold electrode by attachment to a self-assembled monolayer (SAM). The initial SAM can be constructed at the gold surface using a halothioalkane, such as 1-chloro-6-thiohexane, and the step growth begins with attachment of an organodilithium compound to the SAM. The polymers can be grown to exact chain lengths by a sequential, alternating flow cycle, a solution of the organodilithium salt flows over the SAM-coated substrate, a rinse solvent is flowed over the substrate to remove excess organodilithium salt, a solution of the haloborane complex is flowed over the substrate, a rinse solvent is flowed over the substrate to remove excess haloborane complex, then repeat. With each flow of a reagent, the polymer grows by one unit.

### Example 8: Attachment to Composite Ceramics or Electrodes

Directional borane polymers are also grown on SiO₂ surfaces or onto silicon substrates that have been oxidized on one side (to form SiO₂, and functionalized with organo or chlorosilanes as the initial monomer. Hybrid ceramic/organic separators can be fabricated in this manner, since it has been already demonstrated that a SiO₂ layer (˜200 nm) functionalized with polyethylene glycol silanes and lithium salts on a LISCION membrane has little interfacial resistance, with similar conductivity for LISCION with or without SiO₂ between stainless steel electrodes. Interfaces to Li/Si alloys can also fabricated, where a thin Si layer on top of a Li/Si anode can be oxidized (to form SiO₂), followed by functionalization using alkyl silanes.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. An anionic polymer comprising a structure represented by Formula V: 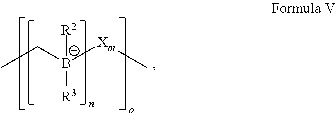
wherein R¹ a divalent linker comprising one or more selected from the group consisting of alkyl, branched alkyl, cycloalkyl, haloalkyl, alkanol, aryl, heteroaryl, arylalkyl, arylalkanol, heteroarylalkyl, and heteroarylalkanol;
wherein R² and R³ are each independently selected from the group consisting of H, F, alkyl, haloalkyl, alkenyl, alkynyl, aryl, cycloalkyl, heteroaryl, heterocycloalkyl, arylalkyl, heteroarylalkyl, cycloalkylalkyl, and heterocycloalkylalkyl, and can optionally be joined to form a ring;
wherein X is a divalent monomer comprising one or more selected from the group consisting of alkyl, branched alkyl, cycloalkyl, haloalkyl, alkanol, aryl, heteroaryl, arylalkyl, arylalkanol, heteroarylalkyl, and heteroarylalkanol;
$$wherein n = 1 - 100 ;$$
$$wherein m = 0 - 100 ;$$
$$and$$
$$wherein o = 1 - 100.$$

2. The anionic polymer of claim 1, wherein the structure of Formula V is represented by Formula VI: 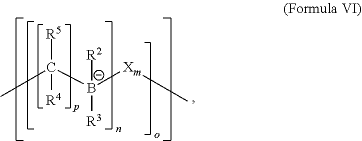
wherein R⁴ and R⁵ are each independently selected from the group consisting of H, F, alkyl, branched alkyl, cycloalkyl, haloalkyl, aryl, alkylaryl, and heteroarylalkyl, and can optionally be joined to form a ring; and
$$wherein p = 1 - 10.$$

3. The anionic polymer of claim 2, wherein R⁴ and R⁵ are H, D, or F.

4. The anionic polymer of claim 1, wherein R² and R³ are H, D, or F.

5. The anionic polymer of claim 1, wherein X is selected from the group consisting of

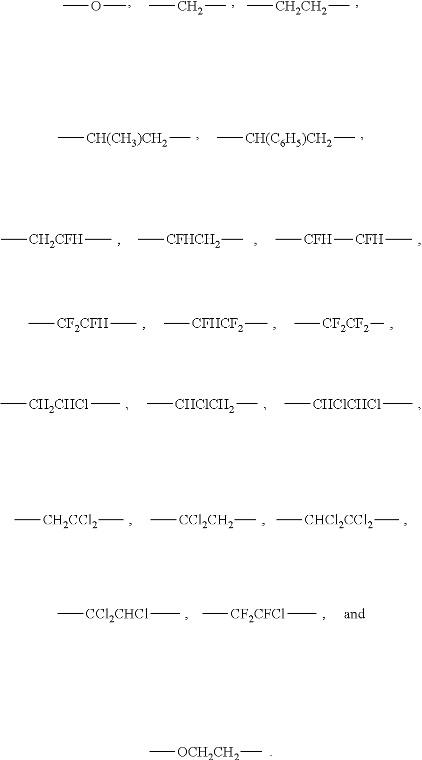

5. The anionic polymer of claim 1, wherein the anionic polymer molecule is adjacent to an ion channel.

6. A composition comprising the anionic polymer of claim 1 and one or more counterions.

7. The composition of claim 6, wherein the one or more counterions are selected from the group consisting of Li⁺, Na⁺, and Mg²⁺.

8. A composition comprising two or more different anionic polymers of claim 1 and one or more counterions.

9. The composition of claim 8, wherein the one or more counterions are selected from the group consisting of Li⁺, Na⁺, and Mg²⁺.

10. A film comprising the anionic polymer of claim 1.

11. A crystal comprising the anionic polymer of claim 1.

12. A solid electrolyte comprising the anionic polymer of claim 1.

13. A battery comprising the electrolyte of claim 12.

14. A method of preparing an anionic polymer, comprising the step of mixing a Lewis acid and a Lewis base to form the anionic polymer of claim 1.

15. The method of claim 14, wherein the Lewis acid is a haloborane and the Lewis base is an organometallic compound.

16. A method of growing the anionic polymer of claim 1 on a substrate, comprising flowing a precursor over the substrate, rinsing the substrate, and flowing a different precursor over the substrate.

17. The method of claim 16, wherein the precursors are selected from the group consisting of a haloborane sulfide and an organometallic compound.

18. The method of claim 16 wherein the substrate is a conductive electrode.
